(19) United States
(12) Patent Application Publication
(10) Pub. No.: US 2024/0177419 A1
(43) Pub. Date: May 30, 2024

(54) MODELING PHOTOREALISTIC FACES WITH EYEGLASSES

(71) Applicant: Meta Platforms Technologies, LLC, Menlo Park, CA (US)

(72) Inventors: Shunsuke Saito, Pittsburgh, PA (US); Junxuan Li, Pittsburgh, PA (US); Tomas Simon Kreuz, Pittsburgh, PA (US); Jason Saragih, Pittsburgh, PA (US); Shun Iwase, Pittsburgh, PA (US); Timur Bagautdinov, Pittsburgh, PA (US); Rohan Joshi, Pittsburgh, PA (US); Fabian Andres Prada Nino, Pittsburgh, PA (US); Takaaki Shiratori, Pittsburgh, PA (US); Yaser Sheikh, Pittsburgh, PA (US); Stephen Anthony Lombardi, Pittsburgh, PA (US)

(21) Appl. No.: 18/522,763

(22) Filed: Nov. 29, 2023

Related U.S. Application Data
(60) Provisional application No. 63/428,703, filed on Nov. 29, 2022.

(51) Int. Cl. G06T 17/10; G06V 10/40

(52) U.S. Cl. CPC G06T 17/10; G06V 10/40; G06T 2207/30201

(57) ABSTRACT

Methods, systems, and storage media for modeling subjects in a virtual environment are disclosed. Exemplary implementations may: receiving, from a client device, image data including at least one subject; extracting, from the image data, a face of the at least one subject and an object interacting with the face, wherein the object may be glasses worn by the subject; generating a set of face primitives based on the face, the set of face primitives comprising geometry and appearance information; generating a set of object primitives based on a set of latent codes for the object; generating an appearance model of photometric interactions between the face and the object; and rendering an avatar in the virtual environment based on the appearance model, the set of face primitives, and the set of object primitives.

### CROSS-REFERENCE TO RELATED APPLICATIONS

The present disclosure is related and claims priority under 35 U.S.C. § 119(e) to U.S. Prov. Application. No. 63/428,703, filed on Nov. 29, 2022, entitled VIRTUAL REPRESENTATIONS OF REAL OBJECTS, to Shunsuke SAITO, et-al., the contents of which are hereby incorporated by reference in their entirety, for all purposes.

### TECHNICAL FIELD

The present disclosure generally relates to improving virtual representations of real subject in a virtual environment, and more particularly to modeling glasses with different materials, and interactions between faces and eyeglasses, rendering more accurate and photorealistic representations of faces.

### BACKGROUND

Virtual presentations of users have become increasingly focal to social presence, and with it, the demand for the digitization of clothes, accessories, and other physical features and characteristics. However, virtual representations do not effectively capture the geometric and appearance interactions between a person and an accessory. For example, modeling the geometric and appearance interactions of glasses and the face for generating a virtual representation (e.g., an avatar) based thereon is a challenge and generally suffers from view and temporal inconsistencies. Thus, they do not faithfully reconstruct all geometric and photometric interactions present in the real world. Conventional generative models also lack structural priors about faces or glasses which leads to suboptimal fidelity. In addition, the generative models are not relightable, thus not allowing us to render glasses on faces in a novel illumination.

As such, there is a need to provide users with improved virtual representations that achieve realism and photorealistic rendering of real objects/accessories interacting with humans in a virtual space.

### BRIEF SUMMARY

The subject disclosure provides for systems and methods for modeling avatars of a subject based on a generative morphable model that enables joint modeling of geometric and photometric interactions of glasses and faces from dynamic multi-view image collections.

One aspect of the present disclosure relates to a method for modeling subjects in a virtual environment. The method may include receiving, from a client device, image data including at least one subject. The method may include extracting, from the image data, a face of the at least one subject and an object interacting with the face. The method may include generating a set of face primitives based on the face, the set of face primitives comprising geometry and appearance information. The method may include generating a set of object primitives based on a set of latent codes for the object. The method may include generating an appearance model of photometric interactions between the face and the object. The method may include rendering an avatar based on the appearance model, the set of face primitives, and the set of object primitives.

Another aspect of the present disclosure relates to a system configured for modeling subjects in a virtual environment. The system may include one or more processors configured by machine-readable instructions. The processor(s) may be configured to receive image data including at least one subject. The processor(s) may be configured to extract from the image data, a face of the at least one subject and an object interacting with the face. The processor(s) may be configured to generate a set of face primitives based on the face, the set of face primitives comprising geometry and appearance information. The processor(s) may be configured to generate a set of latent codes for the object, the set of latent codes including geometry latent codes and appearance latent codes. The processor(s) may be configured to generate a set of object primitives based on the set of latent codes for the object. The processor(s) may be configured to generate an appearance model of photometric interactions between the face and the object. The processor(s) may be configured to render an avatar based on the appearance model, the set of face primitives, and the set of object primitives.

Yet another aspect of the present disclosure relates to a non-transient computer-readable storage medium having instructions embodied thereon, the instructions being executable by one or more processors to perform a method for modeling subjects in a virtual environment. The method may include receiving, from a client device, image data including at least one subject. The method may include extracting, from the image data, a face of the at least one subject and an eyeglass interacting with the face. The method may include generating a set of face primitives based on the face, the set of face primitives comprising geometry and appearance information. The method may include generate a set of latent codes for the eyeglass, the set of latent codes including geometry latent codes and appearance latent codes. The method may include generating a set of eyeglass primitives based on the set of latent codes for the eyeglass. The method may include generating an appearance model of photometric interactions between the face and the eyeglass. The method may include rendering an avatar based on the appearance model, the set of face primitives, and the set of eyeglass primitives.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an overview of devices on which some implementations of the disclosed technology can operate.

FIG. 2 is general framework overview of a generative morphable eyeglass network, in accordance with one or more implementations.

FIG. 3 is a workflow of the morphable geometry module of the generative face model of FIG. 2, in accordance with one or more implementations.

FIG. 4 is a workflow of the relightable appearance module of the generative face model of FIG. 2, in accordance with one or more implementations.

FIGS. 5A-5I are illustrations of exemplary data acquired for learning, in accordance with one or more implementations.

FIG. 6 illustrates eyeglass swapping on a rendered photorealistic avatar using the generative morphable eyeglass model, in accordance with one or more implementations.

FIGS. 7A-7B illustrated exemplary rendering features, in accordance with one or more implementations.

FIG. 8 illustrates lens insertion in glasses frames included in a rendering of a photorealistic avatar, in accordance with one or more implementations.

FIG. 9 illustrates a reconstructed avatar output from the generative morphable eyeglass network, in accordance with one or more implementations.

FIG. 10 illustrates ablation procedures on geometry guidance, in accordance with one or more implementations.

FIG. 11 illustrates ablation procedures on geometry interaction, in accordance with one or more implementations.

FIG. 12 illustrates ablation procedures on a specular feature and appearance interaction, in accordance with one or more implementations.

FIG. 13 illustrates a comparison of avatars, in accordance with one or more implementations.

FIG. 14 illustrates a comparison of avatars, in accordance with one or more implementations.

FIG. 15 illustrates a comparison of avatars, in accordance with one or more implementations.

FIG. 16 illustrates a block diagram of a system configured for rendering models, according to certain aspects of the disclosure.

FIG. 17 is a flow chart illustrating steps in a method for rendering models, according to certain aspects of the disclosure.

FIG. 18 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Virtual presentations of users have become increasingly focal to social presence, and with it, the demand for the digitization of clothes, accessories, and other physical features and characteristics. Particularly, eyeglasses play an important role in the perception of identity. Authentic virtual representations of faces can benefit greatly from their inclusion. However, virtual representations do not effectively capture the geometric and appearance interactions between a person and an accessory such as glasses. Glasses and faces deform each other's geometry at their contact points. Similarly, the appearance is coupled via global light transport, and shadows as well as inter-reflections may appear and affect the radiance, and also induce appearance changes due to light transport. Thus, traditional models, modeling the geometric and appearance interactions of glasses and the face of virtual representations of humans, do not capture these physical interactions since they model eyeglasses and faces independently.

Conventional real time graphics engines support the composition of individual components (e.g., hair, clothing), but the interaction between the face and other objects is by necessity approximated with overly simplified physically inspired constraints or heuristics (e.g., “no interpenetrations”). Thus, they do not faithfully reconstruct all geometric and photometric interactions present in the real world and are typically not real time with physics-based rendering. Others attempt to resolve interactions as a 2D image synthesis problem and suffer from view and temporal inconsistencies. The lack of 3D information including contact and occlusion leads to limited fidelity and incoherent results in motion and changing views. Generative modeling for faces and glasses may be able to span the shape and appearance variation of each object category, however, interactions between objects are not considered in these approaches, leading to implausible object compositions.

Additionally, conventional generative models also lack structural prior leads about faces or glasses which leads to suboptimal fidelity and failure to model photorealistic interactions. In addition, the generative models are not relightable, thus preventing glasses from being rendered on faces in a novel illumination. Standard representations cannot handle such diverse materials, which exhibit significant transmissive effects, and inferring their parameters for photorealistic relighting remains challenging.

Embodiments, as disclosed herein, describe methods and systems that provide a solution rooted in computer technology, namely, a 3D morphable and relightable eyeglass model that represents the shape and appearance of eyeglasses frames and their interaction with faces to generate photorealistic virtual representations (e.g., avatars). Rather than modeling eyeglasses in isolation, the model considers the eyeglasses and its interaction with the face to achieve photorealism. Aspects of embodiments model the geometric and photometric interactions between eyeglasses frames and faces, accurately incorporating high-fidelity geometric and photometric interaction effects to better capture the representation of eyeglasses interacting with a face.

According to embodiments, the model may contain explicit volumetric primitives that move and deform to efficiently allow expressive animation with semantic correspondences across frames. Unlike conventional volumetric approaches, model naturally retains correspondences across glasses, and hence explicit modification of geometry, such as lens insertion and frame deformation, is greatly simplified.

In some embodiments, to support the large variation in eyeglass topology efficiently, a hybrid representation that combines surface geometry and a volumetric representation is employed. Employing the hybrid representation offers explicit correspondences across glasses, as such, the model can trivially deform the structure of glasses based on head shapes.

In some embodiments, the model may be conditioned by a high-fidelity generative human head model, allowing the model to specialize deformation and appearance changes caused by wearing glasses. In some embodiments, the model may include a morphable face model based on glasses-conditioned deformation and appearance networks that incorporate the interaction effects caused by wearing glasses. In some implementations, glasses frames are modeled without lens to avoid modeling lens refraction.

According to embodiments, methods incorporate physics based neural lighting into the generative modeling. The methods infer output radiance given view, point-light positions, visibility, and specular reflection with multiple lobe sizes. The generative model is relightable under point lights and natural illumination. This significantly improves generalization and supports subsurface scattering, reflections, and high-fidelity rendering of various materials including translucent plastic and metal within a single model. Embodiments model global light transport effects, such as casting shadows between faces and glasses and can be fit to novel glasses via inverse rendering.

In some implementations, as a preprocess, glasses geometry may be separately reconstructed using, for example, a differentiable neural signal distance function (SDF) from multi-view images. Regularization terms based on these precomputed glasses geometry significantly improves the fidelity of the model.

### Example Architecture

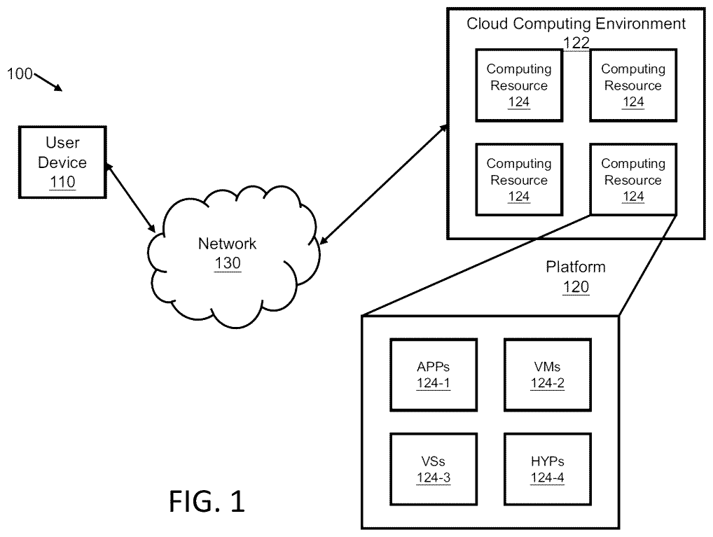

FIG. 1 is a diagram of an environment 100 in which methods, apparatuses and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a headset or other wearable device (e.g., virtual reality or augmented reality headset, smart glasses, a smart watch), or a similar device. In some implementations, the user device 110 may receive information from and/or transmit information to the platform 120 via the network 130.

The platform 120 includes one or more devices as described elsewhere herein. In some implementations, the platform 120 may include a cloud server or a group of cloud servers. In some implementations, the platform 120 may be designed to be modular such that software components may be swapped in or out. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, data storage (e.g., a database), etc., services that do not require end-user (e.g., the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The computing resource 124 may include an application programming interface (API) layer, which controls applications in the user device 110. API layer may also provide tutorials to users of the user device 110 as to new features in the application. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2. The application 124-1 may include one or more modules configured to perform operations according to aspects of embodiments. Such modules are later described in detail.

The virtual machine 124-2 includes a software implementation of a machine (e.g., a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program and may support a single process. In some implementations, the virtual machine 124-2 may execute on behalf of a user (e.g., the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. Virtualized storage 124-3 may include storing instructions which, when executed by a processor, causes the computing resource 124 to perform at least partially one or more operations in methods consistent with the present disclosure. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g., “guest operating systems”) to execute concurrently on a host computer, such as the computing resource 124. The hypervisor 124-4 may present a virtual operating platform to the guest operating systems and may manage the execution of the guest operating systems. Multiple instances of a variety of operating systems may share virtualized hardware resources.

The network 130 can include, for example, any one or more of a local area network (LAN), a wide area network (WAN), the Internet, and the like. Further, network 130 can include, but is not limited to, any one or more of the following network topologies, including a bus network, a star network, a ring network, a mesh network, a star-bus network, tree or hierarchical network, and the like.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

The subject disclosure provides for systems and methods for modeling faces and eyeglasses using a generative morphable eyeglass network. The network includes a morphable geometry component and relightable appearance component to provide a generative model of eyeglasses and faces as well as the interactions between them which may be translated to uses in virtual environments, for example, via avatars/virtual representations. Embodiments enable the joint modeling of geometric and photometric interactions of glasses and faces from dynamic multi-view image collections.

Implementations described herein address the aforementioned shortcomings and other shortcomings by providing a method that correctly models glasses with different materials, and interactions between face and eyeglasses using the generative model. The generative model of eyeglasses represents topology varying shape and complex appearance of eyeglasses using a hybrid mesh-volumetric representation. A physics-inspired neural relighting approach may also be implemented to support global light transport effects of diverse materials in a single model.

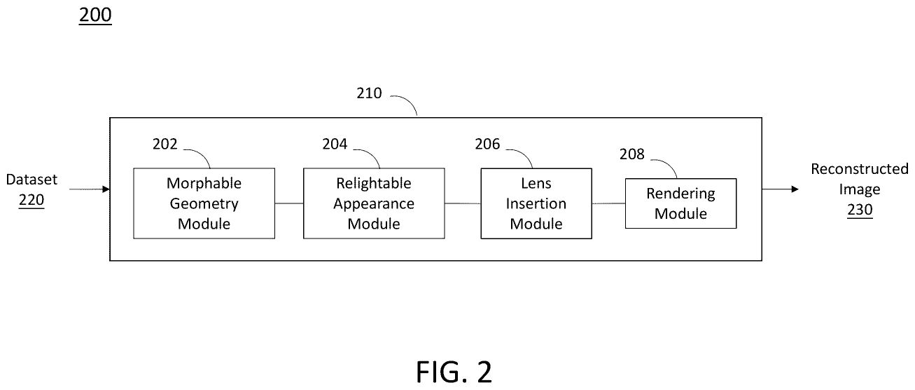

FIG. 2 is general framework overview of a generative morphable eyeglass network 200 used to render a model, according to one or more embodiments. As shown in FIG. 2, the generative morphable eyeglass model 210 of the network 200 may consider two main components, morphable geometry module 202 and relightable appearance module 204, to support the exchange of eyeglasses on faces.

By training based on dataset(s) 220 including various face in varies illuminations and eyeglasses on faces with and without eyeglasses, the generative morphable eyeglass model 210 enables smooth eyeglasses swapping, directional light rendering, environment map rendering, and lens insertion for few-shot reconstruction of images. The generative morphable eyeglass network 200 is able to generate new (generative) eyeglasses via latent code modification and supports replacing relightable materials while retaining shapes.

The morphable geometry module 202 separately learns a generative face model and a generative eyeglass model to model variations in faces and eyeglasses, as well as their geometric interactions such that the models can be composed together. The relightable appearance module 204 accurately renders relightable appearance by computing features that represent light interactions with a relightable face model to allow for joint face and eyeglass relighting. The relightable appearance module 204 correctly models glasses with different materials, and interactions between face and eyeglasses.

A lens insertion module 206 may be configured to enable lens insertion with appealing lens reflection and refraction effects. Once trained, the generative morphable eyeglass model 210 can reconstruct and re-light an unseen eyeglass with only a few inputs. According to embodiments, the generative morphable eyeglass network 200 retains correspondences between primitives. Thus, inserting a lens in generated glasses is trivial by selecting control points for the lens contour on a single template. In some embodiments, the lens insertion module 206 is further configured to incorporate physically accurate refraction and reflection based on glasses prescriptions.

A rendering module 208 may be configured to render a reconstructed photorealistic composition of eyeglasses on a volumetric avatar's head from any viewpoint under novel illuminations generated based on the generative morphable eyeglass model 210 and output the reconstructed image 230. The generative morphable eyeglass network 200 supports differentiable rendering models (or avatars), enabling few-shot reconstruction from a few-view images via inverse rendering. The non-relightable and relightable appearance models share the same latent codes. Therefore, the rendering module 208 renders few-shot reconstruction using only fully lit illumination from novel illuminations.

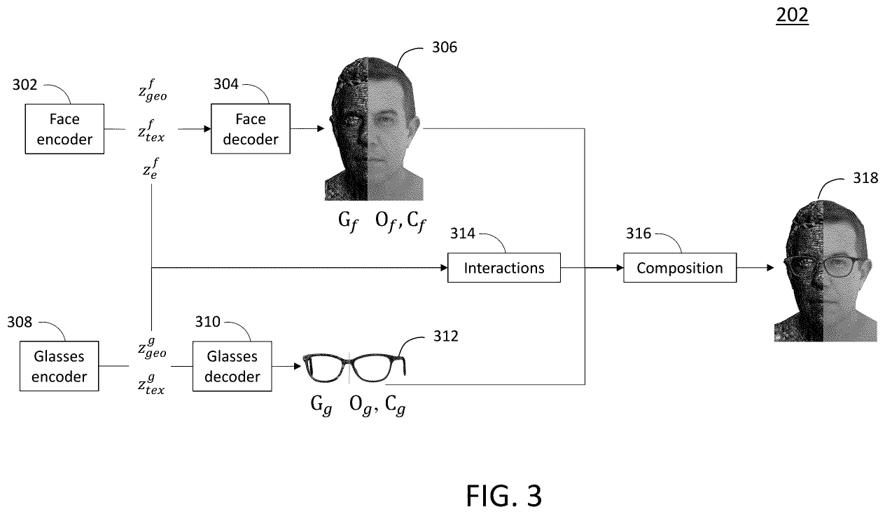

FIG. 3 is a detailed workflow of the morphable geometry module 202 of the generative face model of FIG. 2, according to one or more embodiments.

According to embodiments, the generative morphable eyeglass model is based on Mixture of Volumetric Primitives (MVP), a distinct volumetric neural rendering approach that achieves high-fidelity renderings in real-time. The generative morphable eyeglass model contains explicit volumetric primitives that move and deform to efficiently allow expressive animation with semantic correspondences across frames. Unlike mesh-based approaches, the generative morphable eyeglass model supports topological changes in geometry.

To model faces without glasses, the generative face model adopts a pretrained face encoder 302 and face decoder 304. Given an encoding of a facial expression zₑ^{f}, and face identity encoding of geometry z_{geo}^{f} and textures zₜₑₓ^{f}, the face primitive geometry and appearance 306 are decoded as:

G_{f}, O_{f}, C_{f}= [symbol] _{f}(zₑ^{f}, z_{geo}^{f}, zₜₑₓ^{f}) Equation (1)

where [symbol] _{f} is the face decoder 304, G_{f}={t, R, s} is the tuple of the position t∈ [symbol] ^{3×N}^{_{fprim}}, rotatioon R∈ [symbol] ^{3×3×N}^{_{fprim}} and scale s∈ [symbol] ^{3×N}^{_{fprim}} of face primitives;

$${O}_{f} ∈ {ℝ}^{{M}^{3} \times {N}_{fprim}}$$

is the opacity of face primitives;

$${C}_{f} ∈ {ℝ}^{3 \times {M}^{3} \times {N}_{fprim}}$$

is the RGB color of face primitives in fully lit images. N_{fprim} denotes the number of face primitives and M denotes the resolution of each of the primitives. In some implementations, N_{fprim} is set to equal 128×128 and M is set to equal 8.

To model glasses, the generative eyeglass model includes a variational auto-encoder (hereafter “glasses encoder 308”) and glasses decoder 310. The glasses encoder 308 may encode according to the following equation:

z_{geo}^{g}, zₜₑₓ^{g}=ε_{g}(w_{id}^{g}) Equation (2)

where ε_{g} is the glasses encoder 308 that takes a one-hot-vector w_{id}^{g} of glasses at input and generates both geometry and appearance latent codes for the glasses z_{geo}^{g}, zₜₑₓ^{g} as output. The latent codes are decoded at the glasses decoder 310 to generate glasses primitives 312 as follows:

C_{g}, O_{g}, C_{g}= [symbol] _{g}(z_{geo}^{g}, zₜₑₓ^{g}) Equation (3)

where [symbol] _{g} is the glasses decoder 310, G_{g}={t_{g}, R_{g}, s_{g}} is the tuple of the position, rotation, and scale of the eyeglass primitives, with position t_{g}∈ [symbol] ^{3×N}^{_{gprim}}, rotation R_{g}∈ [symbol] ^{3×3×N}^{_{gprim}}, and scale s_{g}∈ [symbol] ^{3×N}^{_{gprim}};

$${O}_{g} ∈ {ℝ}^{{M}^{3} \times {N}_{gprim}}$$

is the opacity or glasses primitives;

$${C}_{g} ∈ {ℝ}^{3 \times {M}^{3} \times {N}_{gprim}}$$

is the RGB color of glasses primitives in fully lit images. N_{gprim} denotes the number of glasses primitives. In some implementations, N_{fprim} is set to equal 32×32. As such, the faces and glasses are modeled in isolated latent spaces.

The deformation caused by the interaction between glasses and faces is modeled as residual deformation of the primitives. Interactions 314 computes the residual deformations G_{δf}, G_{δg} of the primitives as follows:

G_{δf}= [symbol] _{δf}(zₑ^{f},z_{geo}^{g},z_{geo}^{f}) Equation (4)

G_{δg}= [symbol] _{δg}(zₑ^{f},z_{geo}^{g},z_{geo}^{f}) Equation (5)

where G_{δf}={δₜ,δ_{R},δₛ} and G_{δ}_{_{g}}={δₜ_{_{g}}, δ_{R}_{_{g}}, δₛ_{_{g}}} are the residuals in position, rotation, and scale from their values in the canonical space. The interaction may influence the eyeglasses in two different ways: non-rigid deformations caused by fitting to the head, and rigid deformations caused by facial expressions. According to embodiments, the two effects are modeled individually to better generalize to a novel combination of glasses and an identity. The deformation residuals may be modeled as:

[symbol]

_{δ}_{_{g}}(⋅)= [symbol] _{deform}(z_{geo}^{g},z_{geo}^{f})+ [symbol] _{transf}(zₑ^{f},z_{geo}^{g}) Equation (6)

where [symbol] _{deform} takes facial identity information to deform the eyeglasses to the target head, and [symbol] _{transf} takes expression encoding as input to model the relative rigid motion of eyeglasses on face caused by different facial expressions (e.g., sliding up when wrinkling the nose). Composition 316 composes the generative face and glasses models, and their interactions together (i.e., G_{f}+G_{δf}, O_{f}, C_{f} to model faces; and G_{g}+G_{δ}_{_{g}}, O_{g}, C_{g} to model glasses) to generate a composed face with glasses 318.

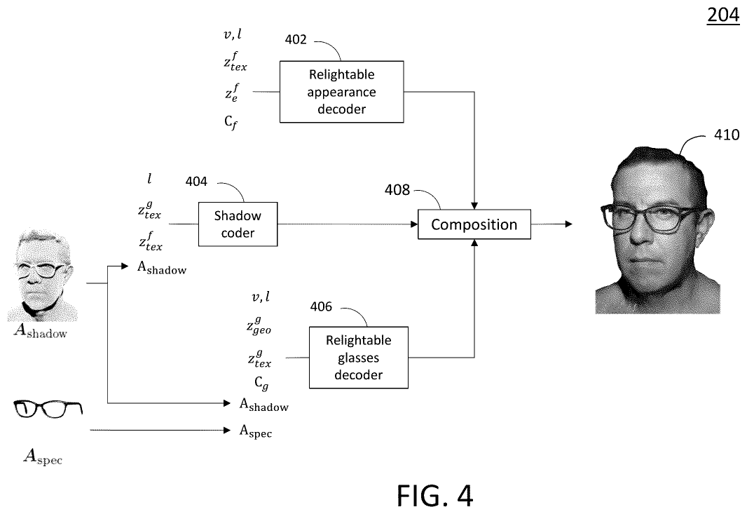

FIG. 4 is a detailed workflow of the relightable appearance module 204 of the generative face model of FIG. 2, according to one or more embodiments.

According to embodiments, the appearance values of primitives under the uniform tracking illumination of the morphable geometry module 202 (i.e., C_{f} and C_{g}) are used for learning geometry and the deformation caused by interactions. According to embodiments, the relightable appearance module 204 enables relighting of the generative face model by introducing a relightable appearance decoder 402 to model a relightable face in a relightable appearance model. The relightable appearance decoder 402 is trained on facial expression zₑ^{f} and the encoding of the face textures zₜₑₓ^{f}, and additionally conditioned on view direction v and light direction l to decode and generate an appearance A_{f} as:

A_{f}= [symbol] _{f}(zₑ^{f},v,l,zₜₑₓ^{f},C_{f}) Equation (7)

where [symbol] _{f} is the relightable appearance decoder 402,

$${A}_{f} ∈ {ℝ}^{3 \times {M}^{3} \times {N}_{fprim}}$$

is the appearance slab consisting of RGB colors under a single point-light.

To model the photometric interaction of eyeglasses on faces, the photometric interactions are considered as residuals conditioned by an eyeglasses latent code, similar to the deformation residuals. Light features, such as shadow and specular features, that represent light interactions are computed. Cast shadows are the most noticeable appearance (light) interactions of eyeglasses on the face. Therefore, the generative face model includes a shadow coder 404 with a shadow feature as an input to facilitate shadow modeling as:

A_{δf}= [symbol] _{δf}(l,zₜₑₓ^{g},zₜₑₓ^{f},A_{shadow}) Equation (8)

where [symbol] _{δf} is the shadow coder 404,

$${A}_{δ f} ∈ {ℝ}^{3 \times {M}^{3} \times {N}_{fprim}}$$

is the appearance residual for the face; and

$${A}_{shadow} ∈ {ℝ}^{{M}^{3} \times {N}_{fprim}}$$

is the snadow feature computed by accumulating opacity while ray-marching from each of the light sources to the primitives, representing light visibility. Thus, the shadow feature represents the first bounce of light transport on both the face and glasses.

The relightable glasses appearance is modeled similarly to the relightable face. According to embodiments, to target modeling eyeglasses on faces, the relightable glasses appearance may be define as a conditional model with face elements so that occlusion and multiple bounces of lights by an avatar's head is already incorporated in the appearance. The relightable glasses decoder 406 is trained on facial expression zₑ^{f}, the encoding of the face textures zₜₑₓ^{f}, color of glasses primitives C_{g}, and additionally conditioned on view direction v, light direction l, shadow feature, and specular feature to decode and generate a glasses appearance A_{g} as:

A_{g}= [symbol] _{g}(v,l,zₜₑₓ^{g},z_{geo}^{g},A_{shadow},A_{spec},C_{g}) Equation (9)

where

$${A}_{g} ∈ {ℝ}^{3 \times {M}^{3} \times {N}_{gprim}}$$

is the glasses appearance slab, and

$${A}_{spec} ∈ {ℝ}^{3 \times {M}^{3} \times {N}_{gprim}}$$

is the specular feature; A_{shadow} is the shadow feature computed according to Equation (8), which encodes face information.

Composition 408 generates a photorealistic avatar 410 that models geometric and photometric interactions between the glasses and the face with full relighting by composing the appearance and residual of the face (i.e., A_{f}+A_{δf}) and the glasses appearance A_{g}.

In some embodiments, the specular feature A_{spec} is computed at every point on the primitives based on normal, light and view directions with a specular Bidirectional Reflectance Distribution Function (BRDF) parameterized as Spherical Gaussians with three different lobes. Explicitly conditioning specular reflections significantly improves the fidelity of relighting and generalization to various frame materials.

According to embodiments, the predicted volumetric primitives may be rendered using differentiable volumetric rendering. The position of all primitives in the space may be denoted as G. Thus, when only rendering the face without wearing any eyeglasses, the of the face primitives would be denoted as G=G_{f} and when rendering the face wearing glasses would be denoted as G={G_{f}+G_{δf}, G_{g}+G_{δg}}. Similarly, the opacity of all primitives in the space may be denoted as O, taking form O=O_{f} or O={O_{f}, O_{g}} for rendering without and with glasses, respectively. The color of all primitives in the space may be denoted as C, where C=C_{f} and C={C_{f},C_{g}} in fully lit images, and C=A_{f} and C={A_{f}+A_{δf}, A_{g}} in relighting frames. Differentiable volumetric aggregation is then used to render images based on the face, opacity, and color primitives G, O, C, respectively.

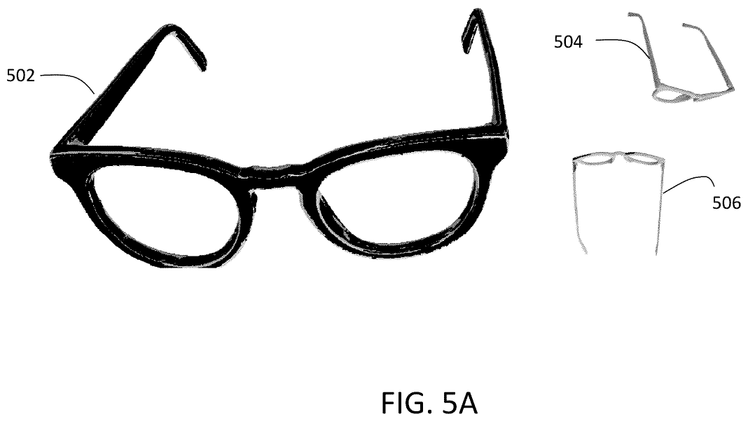

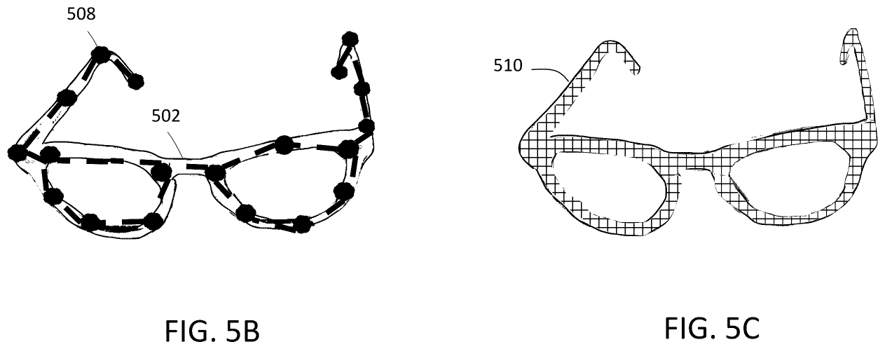

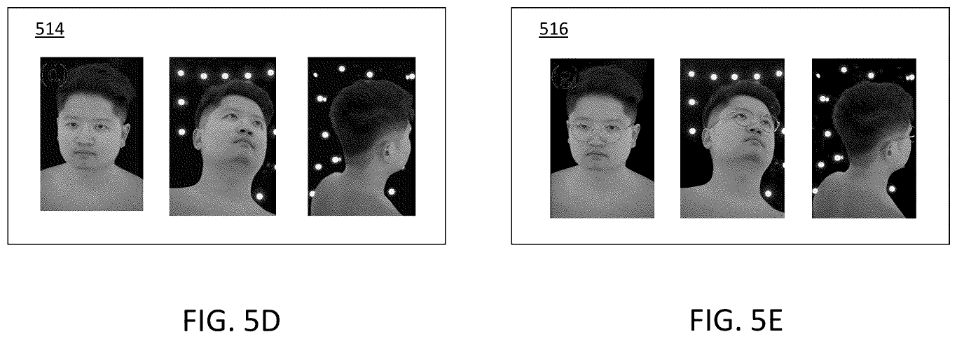

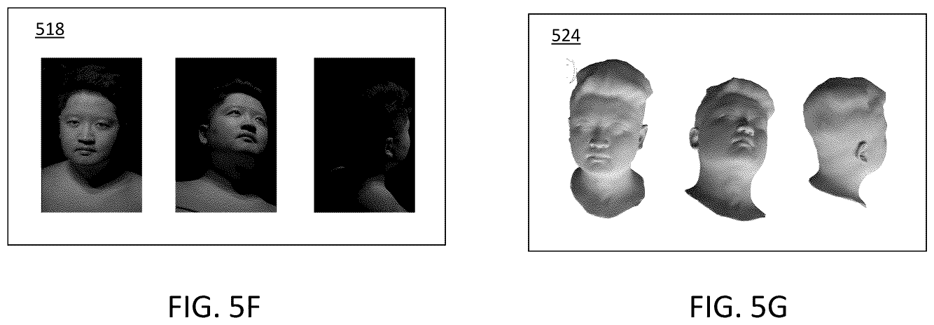

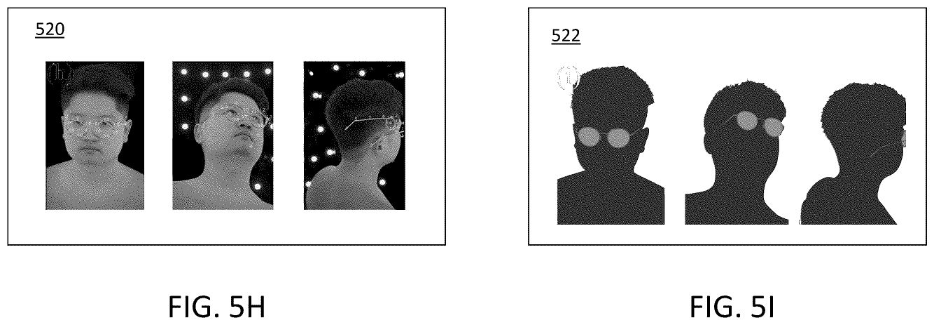

FIGS. 5A-5I are illustrations of exemplary data acquired for learning, according to one or more embodiments. The generative morphable eyeglass model aims to learn a generative model of eyeglasses and faces as well as the interactions between them. Therefore, the generative morphable eyeglass model captures three types of data in datasets: eyeglasses, faces, and faces with eyeglasses.

In some embodiments, lenses from eyeglasses may be removed for all datasets to decouple learning frame style from lens effects (which vary across prescriptions).

In some embodiments, a set of eyeglasses may be selected from the datasets to cover a wide range of sizes, styles, and materials, including metal and translucent plastics of various colors. Multi-view images (e.g., 70 multi-view images) may be captured for each eyeglasses instance using a capture system (e.g., user device 110). In some implementations, the dataset is captured using a multi-view light-stage capture system (e.g., a camera). FIG. 5A illustrates an image of glasses 502 and multi-view images 504, 506 of the glasses 502. For each of the glasses (e.g., glasses 502, and multi-view images 504, 506), key points are identified. FIG. 5B illustrates the key point detections 508 of the glasses 502.

Three-dimensional (3D) meshes of each of the eyeglasses are extracted using, for example, a surface reconstruction method. FIG. 5C illustrates an exemplary eyeglass mesh 510 extracted based on the glasses 502. The 3D meshes will later provide supervision for the eyeglasses MVP geometry. However, glasses change geometrically once they are worn. Therefore, embodiments implement Bounded Biharmonic Weights (BBW) to define a coarse deformation model that is used to fit the meshes to the face with eyeglasses dataset using the key point detections 508.

According to embodiments, a dataset of faces without eyeglasses and the same set of faces with eyeglasses are captured. The dataset may include a set of subjects (e.g., 25 subjects). FIG. 5D illustrates a set of images 514 consisting of a subject without glasses captured using a multi-view light-stage capture system with cameras. For example, the subject may be instructed to perform various facial expressions, yielding recordings with changing expressions and head pose. Each subject may be captured a specified number of times. For example, each subject is captured three times: a first frame without glasses, and a second frame and a third frame wearing a random selection of glasses out of the set of glasses. The frames may be captured at different camera viewpoints. FIG. 5E illustrates images of a set of faces with eyeglasses 516 of the subject wearing randomly selected glasses.

To allow for relighting, the data is captured under different illumination conditions. As such, the capture system uses time-multiplexed illuminations. Fully lit frames (i.e., frames for which all lights on the light stage are turned on) may be interleaved every third frame to allow for tracking, and the remaining two thirds of the frames are used to observe the subject under changing lighting conditions where only a subset of lights (“group” lights) are turned on, as shown in FIG. 5F which illustrates the set of images 518 with only the subset of lights turned on.

According to embodiments, the data is pre-processed using a multi-view face tracker to generate a coarse but topologically consistent face mesh for each frame. For example, a first face mesh, a second face mesh, and a third face mesh may be generated corresponding to the first, second, and third frames, respectively. FIG. 5G illustrates face meshes 524 generated based on the frames captured set of images 514. Tracking and detections are performed on the fully lit frames and interpolated to partially lit frames when necessary. A set of key points (e.g., 20 key points) are detected on the eyeglasses for the set of faces with eyeglasses portion of the dataset. FIG. 5H illustrates the set of faces with eyeglasses (e.g., set of faces with eyeglasses 516) with the glasses including a set of key points 520. Face and glasses segmentation masks 522, as shown in FIG. 5I, are also generated. The set of key points on the eyeglasses for the set of faces with eyeglasses (i.e., 520) and the face and glasses segmentation masks 522 are used to fit the eyeglasses BBW mesh deformation model to match the observed glasses.

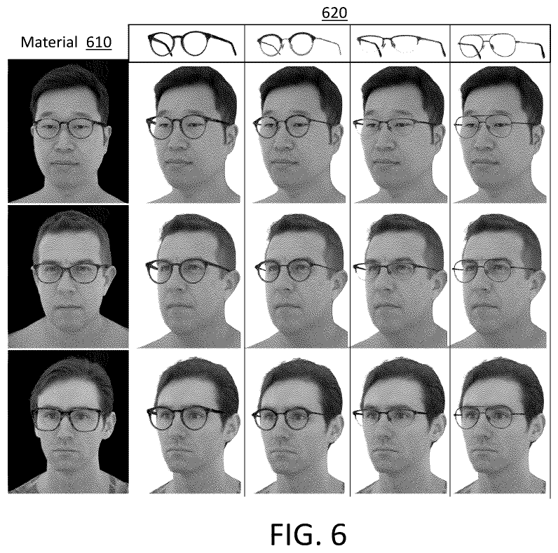

FIG. 6 illustrates eyeglass swapping on a rendered photorealistic avatar using the generative morphable eyeglass model, according to one or more embodiments. The generative morphable eyeglass model generates new eyeglasses via latent code modification, as such, supports changing materials 610 and shapes 620 of glasses while adjusting to varying faces/heads. According to embodiments, glasses may be seamlessly swapped or replaced with other relightable materials while retaining shapes.

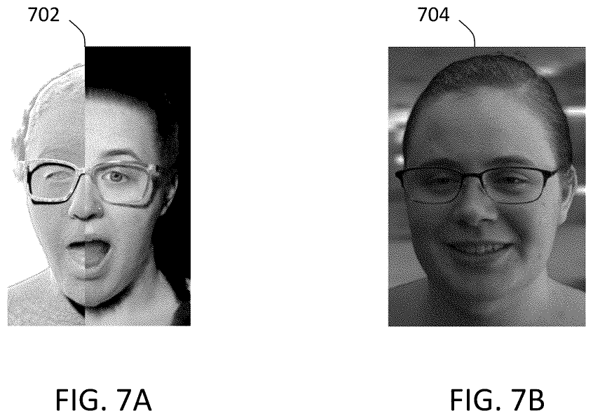

FIGS. 7A-7B illustrated exemplary rendering features, according to one or more embodiments. As shown in FIG. 7A, embodiments may include directional light rendering 702 of avatars (e.g., group lighting). As shown in FIG. 7A, embodiments may include environment map rendering 704.

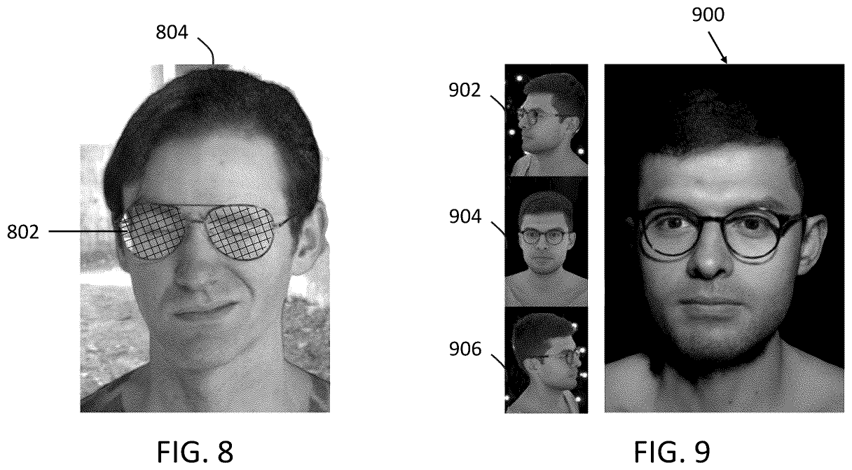

FIG. 8 illustrates lens 820 insertion in glasses frames included in a rendering of a photorealistic avatar 804, according to one or more embodiments. In some embodiments, the lens 820 may include refraction and reflection features based on prescriptions.

FIG. 9 illustrates a reconstructed avatar output from the generative morphable eyeglass network based on an input image 900, according to one or more embodiments. The output includes a first view 902 of the reconstructed avatar, second view 904 of the reconstructed avatar, and third view 906 of the reconstructed avatar from different camera viewpoints.

According to embodiments, the generative morphable eyeglass network 200 may be trained in two stages: morphable geometry training which trains the morphable geometry module 202 and relightable appearance training which trains the relightable appearance module 204. In the first stage, the fully lit images are used to train the geometry of faces and glasses. In the second stage, the images under group lights are used to train the relightable appearance model.

According to embodiments, the morphable geometry training optimizes the parameters Φ_{g} of the expression encoder in ε_{f}, glasses encoder [symbol] _{f}, [symbol] _{g}, G_{δf}, G_{δf} using:

Φ′_{g}=arg_{Φ}_{_{g}}minΣ_{N}_{₁} [symbol] Σ_{N}_{_{F}}ᵢΣ_{N}_{_{C}} [symbol] _{fully-lit}(Φ_{g}I^{i,r}) Equation (10)

where the parameters Φ_{g} are optimized over N_{I} different subjects; N_{F}_{ᵢ} different fully lit frames including with and without glasses; and N_{C} different camera view points; and Iⁱ denotes all the ground truth camera images and associated processed assets for a frame, including face geometry, glasses geometry, face segmentation, and glasses segmentation; likewise, I^{r} denotes the reconstructed images from volumetric rendering and the corresponding assets. The fully lit loss function consists of three main components:

[symbol]

_{fully-lit}(⋅)= [symbol] _{rec}(I^{i,r})+ [symbol] _{gls}(I^{i,r})+ [symbol] _{reg}(Φ_{g}, I^{i,r}) Equation (11)

where the [symbol] _{reg} are photometric reconstruction losses defined as:

[symbol]

_{reg}(⋅)= [symbol] _{L1}(I^{i,r})+ [symbol] _{vgg}(I^{i,r})+ [symbol] _{gan}(I^{i,r}) Equation (12)

where [symbol] _{L1} is the l₁ loss between observed images and reconstruction; [symbol] _{vgg}, [symbol] _{gan} are the VGG and GAN losses. [symbol] _{gls} is the geometry guidance loss calculated based on separately reconstructed glasses (e.g., glasses 502 and multi-view images 504, 506 of the glasses 502) to improve the geometric accuracy of glasses, leading to better separations of faces and glasses in joint training. The joint training may be defined as:

[symbol]

_{gls}(⋅)= [symbol] _{c}(I^{i,r})+ [symbol] ₘ(I^{i,r})+ [symbol] ₛ(I^{i,r}) Equation (13)

including chamfer distance loss [symbol] _{c}; glasses masking loss [symbol] ₘ; and glasses segmentation loss [symbol] ₛ. These losses encourage the network 200 to separate identity-dependent deformations from glasses intrinsic deformations, thus helping the network to generalize on different identities.

In some embodiments, a regularization loss [symbol] _{reg} is introduced in the first training stage as.

[symbol]

_{reg}(⋅)= [symbol] _{KL}(Φ_{g})+ [symbol] _{L2}(Φ_{g}, I^{i,r}) Equation (14)

where [symbol] _{KL}(⋅) is the KL-divergence loss between the prior Gaussian distribution and the distribution of the glasses latent space; and [symbol] _{L2} is a l₂-norm for suppressing the delta deformation of face to reduce large displacements of face primitives.

During training, the weights of each loss term may be set as λ_{L1}=1, λ_{vgg}=1, λ_{gan}=1, λ_{c}=0.01, λₘ=10, λₛ=10, λ_{KL}=10⁻⁴, λ_{L2}=10⁻³.

According to embodiments, once the morphable geometry module 202 is trained, the parameters Φ_{g} are frozen and the relightable appearance training stage starts to train the appearances A_{f}, A_{δf}, A_{g}. Parameters of the appearances A_{f}, A_{δf}, A_{g} are denote as Φₐ. The relightable appearance training optimizes the parameters Φₐ using:

$${Φ}_{a}^{′} = {arg}_{{Φ}_{a}} min {\sum }_{{N}_{I}} {\sum }_{{N}_{{G}_{i}}} {\sum }_{{N}_{C}} {ℒ}_{group - lit} ( {Φ}_{a} , {I}^{i , c} ) \qquad Equation ( 15 )$$

where the parameters Φₐ are optimized over N_{I} different subjects; N_{G}_{ᵢ} different group-lit frames including with and without glasses on the faces; and N_{C} different camera viewpoints.

In some embodiments, for the frames illuminated by group-lights, two nearest fully lit frames may be used to generate face and glasses geometry using G_{f}, G_{g}, G_{δf}, G_{δg}, and linearly interpolate to get face and glasses geometry for the group-light image. The objective function for the second stage is mean-square-error photometric loss [symbol] _{group-lit}(⋅)=∥Iⁱ−I^{c}∥₂². The VGG and GAN loss are not used in relightable appearance training since doing so would introduce block-like artifacts in the reconstruction.

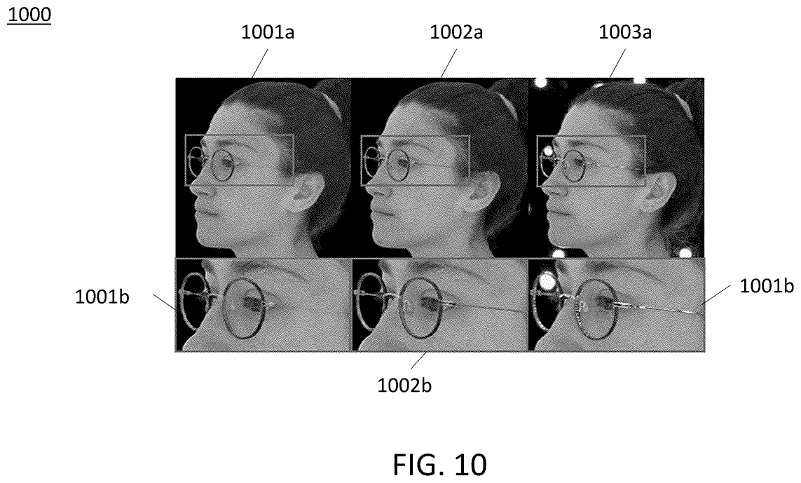

FIG. 10 illustrates ablation procedures 1000 on geometry guidance, according to some embodiments. Procedures 1000 shows the geometry-guided losses, including surface normal and segmentation, is essential for achieving crisp and sharp eyeglasses reconstruction.

Images 1001a, 1001b, 1002a, 1002b are created using input image 1003a is the and image 1003b is the zoomed-in image of the glasses input image 1003a. The model without using geometry guidance is only trained with image-based reconstruction and regularization losses. As shown in FIG. 10, the reconstructed avatar in image 1001a without using geometry guidance fails to reconstruct the detailed geometry of the eyeglasses. The zoomed-in image of the glasses in image 1001b shows that the nose pads lack detail and clarity. Without geometry guidance, the reconstruction led to blurry results. In comparison, the generative morphable eyeglass model with geometry guidance (hereinafter, referred to as “full method”) achieves higher geometric fidelity, generating an avatar in image 1002a with sharp and accurate eyeglasses. The zoomed-in image of the glasses in image 1002b shows the detailing in the nose pads.

Table 1 summarizes the quantitative ablation results of procedures 1000 for each part of the generative morphable eyeglass model. The table shows that the full method results in the best reconstruction/output.

TABLE 1
Quantitative Ablation Results

| Components | l₁(↓) | PSNR(↑) | SSIM(↑) | LPIPS(↓) |
|---|---|---|---|---|
| w/o Geo | 2.374 | 32.55 | 0.8764 | 0.1712 |
| w/o A_{shadow} | 1.870 | 36.63 | 0.9227 | 0.1171 |
| w/o A_{spec} | 1.577 | 37.69 | 0.9377 | 0.1087 |
| Full method | 1.558 | 37.98 | 0.9388 | 0.1034 |

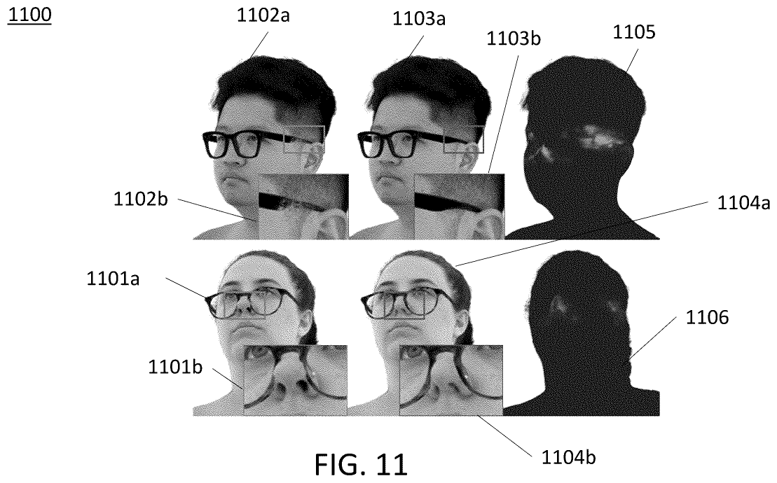

FIG. 11 illustrates ablation procedures 1100 on geometry interaction, according to some embodiments. When they interact, eyeglasses and faces deform each other at contact points. Procedures 1100 shows without modeling such deformations, aspects of the rendering are inaccurate. With the modeling of geometric interactions, the generative morphable eyeglass model learns and faithfully represents the deformation of the head as well as the nose.

As shown in FIG. 11, the reconstructed avatar 1101a without deformation results in obstruction of the glasses by the nose. The zoomed-in image of the glasses 1101b shows that a portion of the glasses appear to be obstructed by the nose and almost appear to be inside the nose. The reconstructed avatar 1102a without deformation shows the legs of eyeglasses being rendered incorrectly and penetrating into the head. The zoomed-in image of the glasses 1102b shows that a portion of the glasses appear to be obstructed by the subject's hair. In comparison, the generative morphable eyeglass model with deformation generates an avatar 1103a, 1104a with accurate interaction rendering, effectively modeling the face deformation. The zoomed-in image of the glasses 1103b, 1104b show the proper accurate rendering at an interaction point between the face/head and the glasses.

In some embodiments, the generative morphable eyeglass network includes generating a deformation heatmap 1105,1106 to illustrate the deformations caused by the interaction between the glasses and the face.

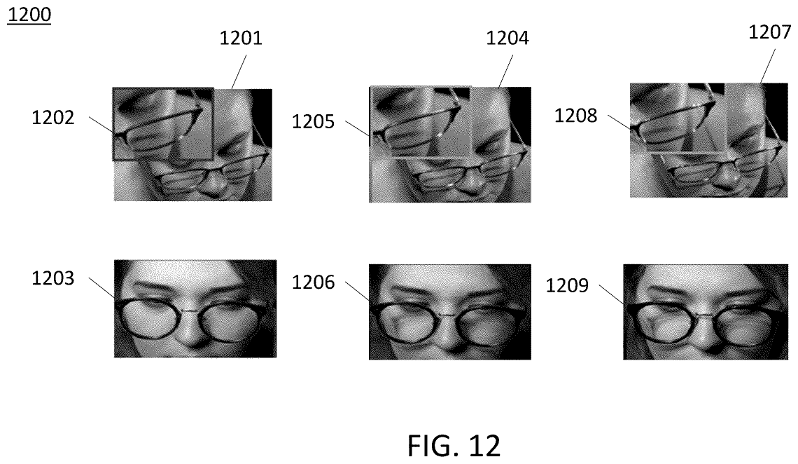

FIG. 12 illustrates ablation procedures 1200 on specular feature and appearance interaction. Procedures 1200 shows physics-inspired features for neural relighting wherein the effectiveness of the proposed specular (A_{spec}) and shadow feature (A_{shadow}) on neural relighting. Images 1201, 1202, 1203, 1204, 1205, 1206 are created using input images 1207, 1209 and image 1208 is the zoomed-in image of the glasses from the input image 1207. As shown in FIG. 12, the rendering without using specular features 1201 fails to reconstruct specular highlights on the frame as highlighted in the zoomed-in image 1202. Furthermore, the model without appearance interaction, as shown in image 1203, fails to reconstruct correct shadows on the face. In contrast, the model with the specular features, as shown in images 1204, 1205, show more details in the glasses and the model with the appearance interaction 1206 shows the correct lighting and shadowing on the face.

Table 1 includes a summarizes of the quantitative ablation results of procedures 1200 tested and evaluated on held-out frames. The table shows that the full method results in the best reconstruction/output. Adding each component effectively improves the performance on all metrics.

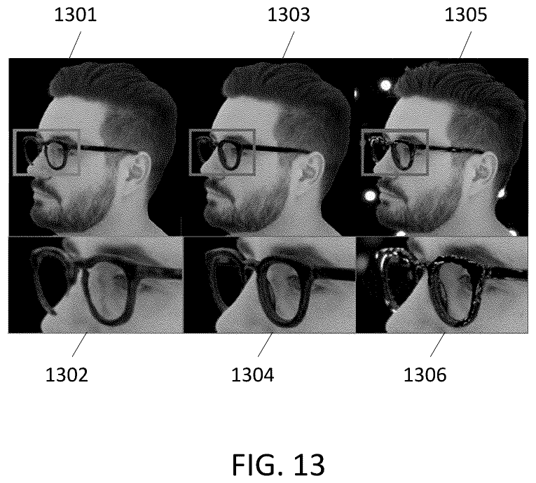

FIG. 13 illustrates a comparison of avatars 1301, 1302, 1303, 1304 generated based on input image 1305, 1306. Avatars 1301, 1302 are generated using a generative latent textured objects (GeLaTO) model and avatars 1303, 1304 are generated using the generative morphable eyeglass model of embodiments. GeLaTO enables generative modeling of eyeglasses, however, assumes that everything except the glasses are static in the scene. GeLaTO is reimplement and trained with our datasets described in FIGS. 5A-5I using ground-truth masks. Since GeLaTO does not support relighting, only fully lit frames are compared in FIG. 13.

As shown in FIG. 13, due to the billboard-based geometry of GeLaTO, the avatar 1301, 1302 renderings lack geometric details and generates incorrect occlusion boundaries. In contrast, the generative morphable eyeglass model achieves high-fidelity results and generates correct occlusions in 3D. Table 2 summarizes quantitative results of the generative morphable eyeglass model and show the model significantly outperforms in all metrics.

TABLE 2
Quantitative comparison with GeLaTO

| Methods | l₁(↓) | PSNR(↑) | SSIM(↑) | LPIPS(↓) |
|---|---|---|---|---|
| GeLaTO | 16.561 | 18.91 | 0.6479 | 0.2576 |
| Ours | 9.202 | 21.80 | 0.7690 | 0.1614 |

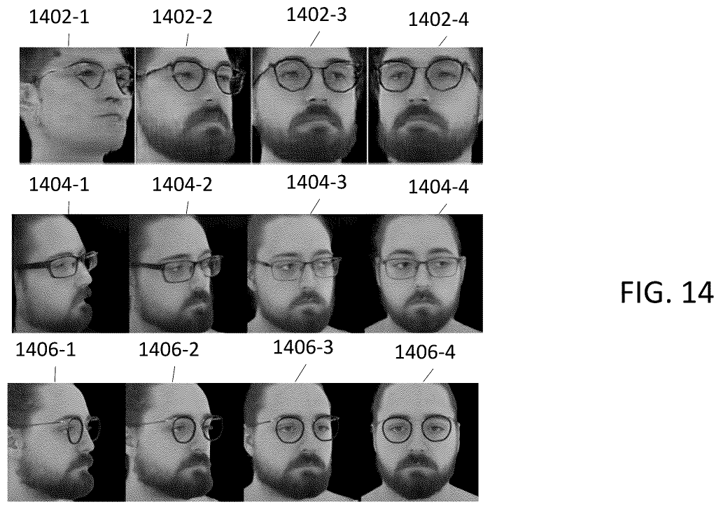

FIG. 14 illustrates a comparison of avatars 1402-1, 1402-2, 1402-3, 1402-4 (hereinafter, collectively referred to as “avatars 1402”) created using GIRAFFE, and avatars 1404-1, 1404-2, 1404-3, 1404-4 (hereinafter, collectively referred to as “avatars 1404”) created using VideoEdit-GAN-based model. Compared with the avatars 1406-1, 1406-2, 1406-3, 1406-4 (hereinafter, collectively referred to as “avatars 1406”) created using the generative morphable eyeglass model, GIRAFFE and VideoEdit-GAN-based model results fail to render view consistent results.

GIRAFFE includes a compositional neural radiance field that supports adding and changing objects in a scene. However, the official implementation only supports objects within the same category. FIG. 14 shows that compositional generative modeling in an unsupervised manner still leads to suboptimal fidelity with limited resolution. VideoEdit-GAN is a SOTA image-based editing method that allows users to insert glasses on face images. As shown in FIG. 14, the image-based approach fails to maintain color and view consistency. Moreover, the approach cannot choose a specific type of glasses. In contrast, the model according to embodiments enables accurate reproduction of glasses and faces with consistent rendering in both view and time.

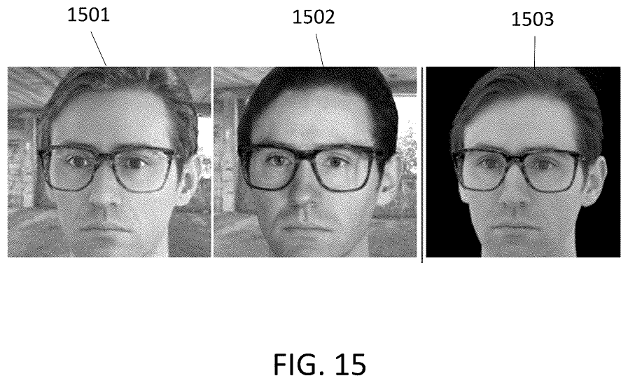

FIG. 15 illustrates a comparison of relighting in avatar 1501 created using a Lumos model based on input image 1503 and avatar 1502 created using the generative morphable eyeglass model based on input image 1503. All the methods mentioned above with reference to FIGS. 13-14 do not support relighting of faces and eyeglasses, thus relighting results of Lumos, a SOTA approach for portrait relighting in image space, is compared with the model according to embodiments. As shown in FIG. 15, due to the lack of 3D information, Lumos has difficulty rendering non-local light transport effects such as shadows cast by eyeglasses. In contrast, the model according to embodiments generates plausible soft shadows, more accurately modeling photometric interactions between faces and glasses.

As such, the generative morphable eyeglass model is a 3D morphable and relightable model used to create photorealistic compositions of eyeglasses on volumetric avatar heads from any viewpoint under novel illuminations. Experiments show (e.g., as shown in FIGS. 7-15) that reproducing geometric and photometric interactions in the real world is possible by leveraging neural rendering with a hybrid mesh-volumetric generative model. By explicitly controlling the motion of primitives, embodiments achieve learning-based modeling of geometric interactions between glasses and faces. Embodiments (e.g., as shown in FIG. 12) also illustrate the effectiveness of physics inspired lighting features as inputs for neural relighting and demonstrate that the generative morphable eyeglass model enables relighting with a diverse set of materials that are both transmissive and reflective using a single generative model. Lastly, the generative morphable eyeglass model allows few-shot fitting to novel glasses, allowing relighting without additional online learning and training data. In some embodiments, the network may include few-shot fitting to in-the-wild images by adopting a test-time finetuning similar or physically accurate fitting of lenses via inverse rendering.

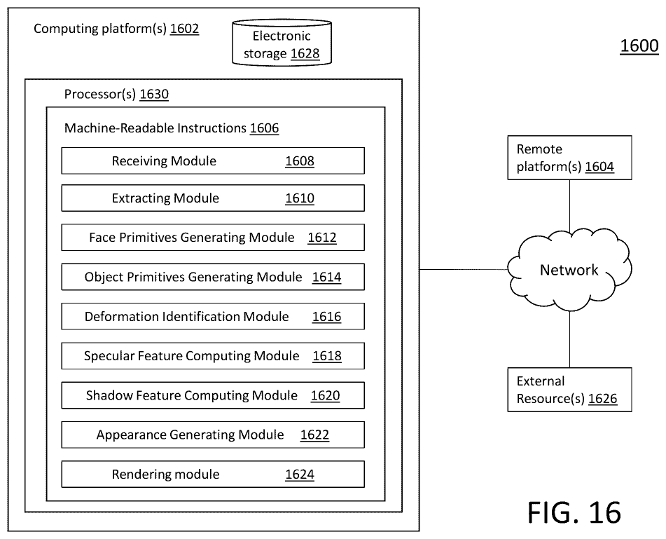

FIG. 16 illustrates a block diagram of a system 1600 configured for rendering models, according to certain aspects of the disclosure. In some implementations, system 1600 may include one or more computing platforms 1602 (e.g., may correspond to platform 120). Computing platform(s) 1602 may be configured to communicate with one or more remote platforms (e.g., computing resource 124) according to a client/server (e.g., user device 110/cloud computing environment 122) architecture, a peer-to-peer architecture, and/or other architectures. Remote platform(s) 1604 may be configured to communicate with other remote platforms via computing platform(s) 1602 and/or according to a client/server architecture, a peer-to-peer architecture, and/or other architectures. Users may access system 1600 via remote platform(s) 1604 or client device.

Computing platform(s) 1602 may be configured by machine-readable instructions 1606. Machine-readable instructions 1606 may include one or more instruction modules. The instruction modules may include computer program modules. The instruction modules may include one or more of receiving module 1608, extracting module 1610, face primitives generating module 1612, object primitives generating module 1614, deformation identification module 1616, specular feature computing module 1618, shadow feature computing module 1620, appearance generating module 1622, rendering module 1624, and/or other instruction modules.

Receiving module 1608 may be configured to receive image data from a client device. The first device may include a VR, MR, AR device, a camera, mobile phone, or the like. The first device may be running a VR/AR application. Image data may include an image of a subject or a scene including at least one subject.

Extracting module 1610 may be configured to identify and extract, from the image data, a face of the at least one subject and an object interacting with the face. The object may be an eyeglass worn by the subject. The extracting module 1610 may be further configured to identify and extract a head of the subject from the image data.

Face primitives generating module 1612 may be configured to generate a set of face primitives based on the face of the subject. The set of face primitives may comprise of geometry and appearance information of the face. In some implementations, the set of face primitives may also include geometry and appearance information of the head of the subject. To generate the set of face primitives, the face primitives generating module 1612 may be further configured to decode an encoding of a facial expression, face geometry, and face textures, wherein the set of face primitives include a tuple of a position, rotation, and scale of the set of face primitives, opacity of face primitives, and color of face primitives.

Object primitives generating module 1614 may be configured to generate a set of latent codes for the object. The set of latent codes may comprise of geometry latent codes and appearance latent codes of the object. A set of object primitives are generated based on the set of latent codes for the object. To generate the set of object primitives, the object primitives generating module 1614 may be further configured to decode the set of latent codes for the object. The set of object primitives may include a tuple of a position, rotation, and scale of the set of object primitives, opacity of object primitives, and color of object primitives.

Deformation identification module 1616 may be configured to identify deformations caused by the object interacting with the face. The deformations include two different deformation types: non-rigid deformation cause by the object fitting to the subject; and rigid deformation caused by facial expressions of the subject.

The deformation identification module 1616 may be further configured to model the deformations as residual deformation of the set of face primitives and the set of object primitives. The residual deformation may be generated addressing the two deformation types by deforming a geometry and an appearance of the object to fit the face (or head) of the subject and inferring a motion of the object on the face. The deforming may be based on the geometry latent codes of the object and facial identity information. The motion of the object on the face may be a result of motion caused by facial expressions of the subject when wearing the object.

Specular feature computing module 1618 may be configured to compute a specular feature at each point on the set of object primitives.

Shadow feature computing module 1620 may be configured to computing a shadow feature representing a first bounce of light transport on the face and the object.

Appearance generating module 1622 may be configured to generating an appearance model of photometric interactions between the face and the object. The appearance model includes a relightable appearance face model. The relightable appearance face model may be generated based on the set of face primitives, and more specifically, facial expression information, facial texture information, and color of face primitives. The appearance model includes a relightable appearance object model. The relightable appearance object model may be generated based on the set of object primitives, and more specifically, object texture information, object identity information, the specular feature, and the shadow feature.

The appearance generating module 1622 may be further configured to model the photometric interaction of objects on faces based on an appearance residual. The appearance generating module 1622 may be further configured to determine the appearance residual for the face based on the shadow feature, light direction, facial texture information in the set of face primitives, and object texture information in the set of object primitives. The view direction and light direction may be identified based on the image data.

Rendering module 1624 may be configured to render an avatar of the subject based on the appearance model, the set of face primitives, and the set of object primitives while adjusting the avatar based on the deformations and photometric interactions between the face and the object. The avatar may be a virtual 3D, photorealistic representation of the subject. The avatar may be rendered in a virtual environment at a second device. The second device may be a VR/AR headset or the like. In some implementations, the first and second devices may be the same or different client devices.

In some implementations, computing platform(s) 1602, remote platform(s) 1604, and/or external resources 1626 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 1602, remote platform(s) 1604, and/or external resources 1626 may be operatively linked via some other communication media.

A given remote platform 1604 may include one or more processors configured to execute computer program modules. The computer program modules may be configured to enable an expert or user associated with the given remote platform 1604 to interface with system 1600 and/or external resources 1626, and/or provide other functionality attributed herein to remote platform(s) 1604. By way of non-limiting example, a given remote platform 1604 and/or a given computing platform 1602 may include one or more of a server, a desktop computer, a laptop computer, a handheld computer, a tablet computing platform, a NetBook, a Smartphone, a gaming console, and/or other computing platforms.

External resources 1626 may include sources of information outside of system 1600, external entities participating with system 1600, and/or other resources. In some implementations, some or all of the functionality attributed herein to external resources 1626 may be provided by resources included in system 1600.

Computing platform(s) 1602 may include electronic storage 1628, one or more processors 1630, and/or other components. Computing platform(s) 1602 may include communication lines, or ports to enable the exchange of information with a network and/or other computing platforms. Illustration of computing platform(s) 1602 in FIG. 16 is not intended to be limiting. Computing platform(s) 1602 may include a plurality of hardware, software, and/or firmware components operating together to provide the functionality attributed herein to computing platform(s) 1602. For example, computing platform(s) 1602 may be implemented by a cloud of computing platforms operating together as computing platform(s) 1602.

Electronic storage 1628 may comprise non-transitory storage media that electronically stores information. The electronic storage media of electronic storage 1628 may include one or both of system storage that is provided integrally (i.e., substantially non-removable) with computing platform(s) 1602 and/or removable storage that is removably connectable to computing platform(s) 1602 via, for example, a port (e.g., a USB port, a firewire port, etc.) or a drive (e.g., a disk drive, etc.). Electronic storage 1628 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1628 may include one or more virtual storage resources (e.g., cloud storage, a virtual private network, and/or other virtual storage resources). Electronic storage 1628 may store software algorithms, information determined by processor(s) 1630, information received from computing platform(s) 1602, information received from remote platform(s) 1604, and/or other information that enables computing platform(s) 1602 to function as described herein.

Processor(s) 1630 may be configured to provide information processing capabilities in computing platform(s) 1602. As such, processor(s) 1630 may include one or more of a digital processor, an analog processor, a digital circuit designed to process information, an analog circuit designed to process information, a state machine, and/or other mechanisms for electronically processing information. Although processor(s) 1630 is shown in FIG. 16 as a single entity, this is for illustrative purposes only. In some implementations, processor(s) 1630 may include a plurality of processing units. These processing units may be physically located within the same device, or processor(s) 1630 may represent processing functionality of a plurality of devices operating in coordination. Processor(s) 1630 may be configured to execute modules 1608, 1610, 1612, 1614, 1616, 1618, 1620, 1622, and/or 1624, and/or other modules. Processor(s) 1630 may be configured to execute modules 1608, 1610, 1612, 1614, 1616, 1618, 1620, 1622, and/or 1624, and/or other modules by software; hardware; firmware; some combination of software, hardware, and/or firmware; and/or other mechanisms for configuring processing capabilities on processor(s) 1630. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 1608, 1610, 1612, 1614, 1616, 1618, 1620, 1622, and/or 1624 are illustrated in FIG. 16 as being implemented within a single processing unit, in implementations in which processor(s) 1630 includes multiple processing units, one or more of modules 1608, 1610, 1612, 1614, 1616, 1618, 1620, 1622, and/or 1624 may be implemented remotely from the other modules. The description of the functionality provided by the different modules 1608, 1610, 1612, 1614, 1616, 1618, 1620, 1622, and/or 1624 described below is for illustrative purposes, and is not intended to be limiting, as any of modules 1608, 1610, 1612, 1614, 1616, 1618, 1620, 1622, and/or 1624 may provide more or less functionality than is described. For example, one or more of modules 1608, 1610, 1612, 1614, 1616, 1618, 1620, 1622, and/or 1624 may be eliminated, and some or all of its functionality may be provided by other ones of modules 1608, 1610, 1612, 1614, 1616, 1618, 1620, 1622, and/or 1624. As another example, processor(s) 1630 may be configured to execute one or more additional modules that may perform some or all of the functionality attributed below to one of modules 1608, 1610, 1612, 1614, 1616, 1618, 1620, 1622, and/or 1624.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

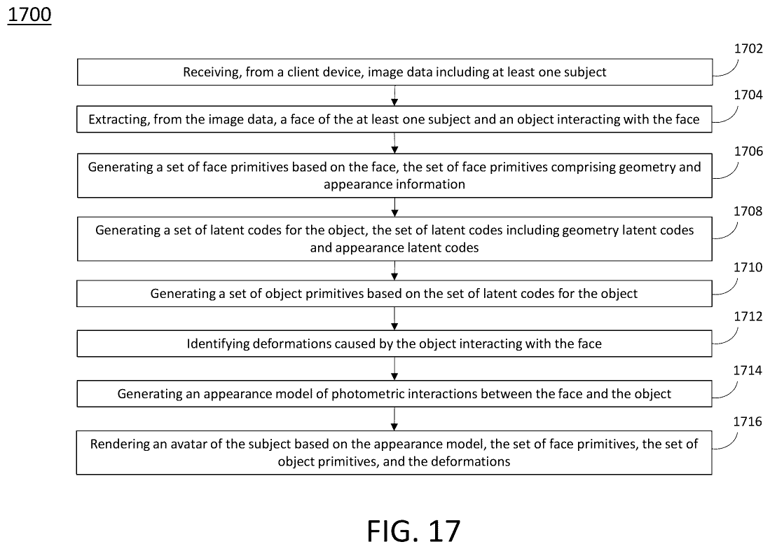

FIG. 17 is a flow chart illustrating steps in a method 1700 for rendering models, according to certain aspects of the disclosure. For explanatory purposes, the example method 1700 is described herein with reference to FIGS. 1-16. Further for explanatory purposes, the steps of the example method 1700 are described herein as occurring in serial, or linearly. However, multiple instances of the example method 1700 may occur in parallel.

At step 1702, the method 1700 includes receiving, from a client device, image data including at least one subject. At step 1704, the method 1700 includes extracting, from the image data, a face of the at least one subject and an object interacting with the face. At step 1706, the method 1700 includes generating a set of face primitives based on the face, the set of face primitives comprising geometry and appearance information. At step 1708, the method 1700 includes generating a set of latent codes for the object, the set of latent codes including geometry latent codes and appearance latent codes. At step 1710, the method 1700 includes generating a set of object primitives based on the set of latent codes for the object. At step 1712, the method 1700 includes identifying deformations caused by the object interacting with the face. At step 1714, the method 1700 generating an appearance model of photometric interactions between the face and the object. At step 1716, the method 1700 rendering an avatar of the subject based on the appearance model, the set of face primitives, the set of object primitives, and the deformations.

According to an aspect, the object is eyeglasses worn by the subject.

According to an aspect, generating the set of face primitives includes decoding an encoding of a facial expression, face geometry, and face textures, wherein the set of face primitives include a tuple of a position, rotation, and scale of the set of face primitives, opacity of face primitives, and color of face primitives.

According to an aspect, generating the set of object primitives includes decoding the set of latent codes for the object, wherein the set of object primitives include a tuple of a position, rotation, and scale of the set of object primitives, opacity of object primitives, and color of object primitives.

According to an aspect, the method 1700 may include modeling the deformations as residual deformation of the set of face primitives and the set of object primitives. The deformations may include non-rigid deformation cause by the object fitting to the subject and rigid deformation caused by facial expressions of the subject.

According to an aspect, the method 1700 may include deforming a geometry and an appearance of the object to fit the face or head of the subject based on geometry latent codes for the object and facial identity information; inferring a motion of the object on the face based on the facial expressions of the subject; and generating the deformation residuals based on the deforming and the motion.

According to an aspect, the appearance model includes: relightable appearance face modeling based on facial expression information, facial texture information in the set of face primitives, and color of face primitive in the set of face primitives; and relightable appearance object modeling based on object texture information in the set of object primitives, object identity information in the set of object primitives, a specular feature, and a shadow feature.

According to an aspect, the method 1700 may include computing a specular feature at each point on the set of object primitives.

According to an aspect, the method 1700 may include computing a shadow feature representing a first bounce of light transport on the face and the object.

According to an aspect, the method 1700 may include identifying a view direction and a light direction based on the image data.

According to an aspect, the method 1700 may include determining an appearance residual for the face based on the shadow feature, light direction, facial texture information in the set of face primitives, and object texture information in the set of object primitives.

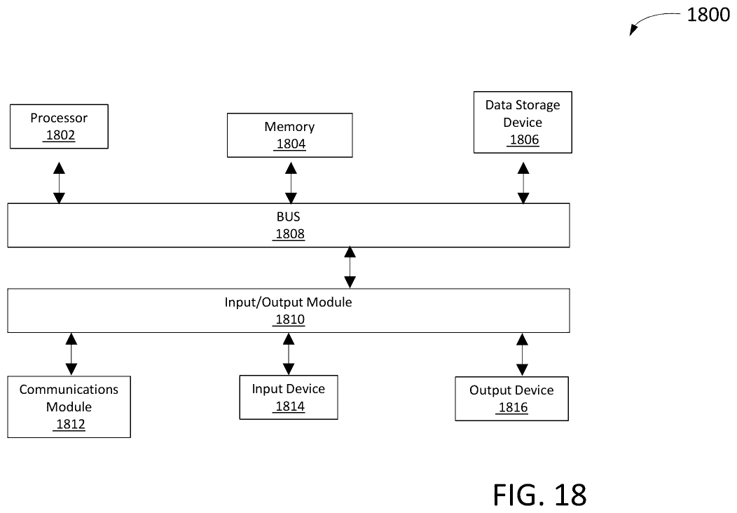

FIG. 18 is a block diagram illustrating an exemplary computer system 1800 with which aspects of the subject technology can be implemented. In certain aspects, the computer system 1800 may be implemented using hardware or a combination of software and hardware, either in a dedicated server, integrated into another entity, or distributed across multiple entities.

Computer system 1800 (e.g., server and/or client) includes a bus 1808 or other communication mechanism for communicating information, and a processor 1802 coupled with bus 1808 for processing information. By way of example, the computer system 1800 may be implemented with one or more processors 1802. Processor 1802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1800 can include, in addition to hardware, code that creates an execution environment for the computer program in question, e.g., code that constitutes processor firmware, a protocol stack, a database management system, an operating system, or a combination of one or more of them stored in an included memory 1804, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1808 for storing information and instructions to be executed by processor 1802. The processor 1802 and the memory 1804 can be supplemented by, or incorporated in, special purpose logic circuitry.

The instructions may be stored in the memory 1804 and implemented in one or more computer program products, i.c., one or more modules of computer program instructions encoded on a computer-readable medium for execution by, or to control the operation of, the computer system 1800, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1804 may also be used for storing temporary variable or other intermediate information during execution of instructions to be executed by processor 1802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1800 further includes a data storage device 1806 such as a magnetic disk or optical disk, coupled to bus 1808 for storing information and instructions. Computer system 1800 may be coupled via input/output module 1810 to various devices. The input/output module 1810 can be any input/output module. Exemplary input/output modules 1810 include data ports such as USB ports. The input/output module 1810 is configured to connect to a communications module 1812. Exemplary communications modules 1812 include networking interface cards, such as Ethernet cards and modems. In certain aspects, the input/output module 1810 is configured to connect to a plurality of devices, such as an input device 1814 and/or an output device 1816. Exemplary input devices 1814 include a keyboard and a pointing device, e.g., a mouse or a trackball, by which a user can provide input to the computer system 1800. Other kinds of input devices 1814 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1816 include display devices such as an LCD (liquid crystal display) monitor, for displaying information to the user.

According to one aspect of the present disclosure, the above-described gaming systems can be implemented using a computer system 1800 in response to processor 1802 executing one or more sequences of one or more instructions contained in memory 1804. Such instructions may be read into memory 1804 from another machine-readable medium, such as data storage device 1806. Execution of the sequences of instructions contained in the main memory 1804 causes processor 1802 to perform the process steps described herein. One or more processors in a multi-processing arrangement may also be employed to execute the sequences of instructions contained in memory 1804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1800 can include clients and servers. A client and server are generally remote from each other and typically interact through a communication network. The relationship of client and server arises by virtue of computer programs running on the respective computers and having a client-server relationship to each other. Computer system 1800 can be, for example, and without limitation, a desktop computer, laptop computer, or tablet computer. Computer system 1800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1802 for execution. Such a medium may take many forms, including, but not limited to, non-volatile media, volatile media, and transmission media. Non-volatile media include, for example, optical or magnetic disks, such as data storage device 1806. Volatile media include dynamic memory, such as memory 1804. Transmission media include coaxial cables, copper wire, and fiber optics, including the wires that comprise bus 1808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1800 reads game data and provides a game, information may be read from the game data and stored in a memory device, such as the memory 1804. Additionally, data from the memory 1804 servers accessed via a network the bus 1808, or the data storage 1806 may be read and loaded into the memory 1804. Although data is described as being found in the memory 1804, it will be understood that data does not have to be stored in the memory 1804 and may be stored in other memory accessible to the processor 1802 or distributed among several media, such as the data storage 1806.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, performed by at least one processor, for modeling subjects in a virtual environment, the method comprising:
receiving, from a client device, image data including at least one subject;
extracting, from the image data, a face of the at least one subject and an object interacting with the face;
generating a set of face primitives based on the face, the set of face primitives comprising geometry and appearance information;
generating a set of object primitives based on a set of latent codes for the object;
generating an appearance model of photometric interactions between the face and the object; and
rendering an avatar based on the appearance model, the set of face primitives, and the set of object primitives.

2. The computer-implemented method of claim 1, wherein the object includes eyeglasses worn by the at least one subject.

3. The computer-implemented method of claim 1, further comprising:
generating the set of latent codes for the object, the set of latent codes including geometry latent codes and appearance latent codes.

4. The computer-implemented method of claim 1, further comprising:
decoding an encoding of a facial expression, face geometry, and face textures, wherein the set of face primitives include a tuple of a position, rotation, and scale of the set of face primitives, opacity of face primitives, and color of face primitives; and
generating the set of face primitives based on the decoding.

5. The computer-implemented method of claim 1, further comprising:
decoding the set of latent codes for the object to generate the set of object primitives, wherein the set of object primitives include a tuple of a position, rotation, and scale of the set of object primitives, opacity of object primitives, and color of object primitives.

6. The computer-implemented method of claim 1, further comprising:
identifying deformations caused by the object interacting with the face; and
modeling the deformations as residual deformation of the set of face primitives and the set of object primitives.

7. The computer-implemented method of claim 6, wherein the deformations include non-rigid deformation cause by the object fitting to the at least one subject and rigid deformation caused by facial expressions of the at least one subject.

8. The computer-implemented method of claim 1, further comprising:
deforming a geometry and an appearance of the object to fit the face or head of the at least one subject based on geometry latent codes for the object and facial identity information;
inferring a motion of the object on the face based on facial expressions of the at least one subject; and
generating deformation residuals based on the deforming and the motion.

9. The computer-implemented method of claim 1, wherein the appearance model includes: relightable appearance face modeling based on facial expression information, facial texture information in the set of face primitives, and color of face primitive in the set of face primitives; and
relightable appearance object modeling based on object texture information in the set of object primitives, object identity information in the set of object primitives, a specular feature, and a shadow feature.

10. The computer-implemented method of claim 1, further comprising:
computing a specular feature at each point on the set of object primitives.

11. The computer-implemented method of claim 1, further comprising:
computing a shadow feature representing a first bounce of light transport on the face and the object;
identifying a view direction and a light direction based on the image data; and
determining an appearance residual for the face based on the shadow feature, light direction, facial texture information in the set of face primitives, and object texture information in the set of object primitives.

12. A system comprising:
one or more processors; and
a memory storing instructions which, when executed by the one or more processors, cause the system to:
receive image data including at least one subject;
extract from the image data, a face of the at least one subject and an object interacting with the face;
generate a set of face primitives based on the face, the set of face primitives comprising geometry and appearance information;
generate a set of latent codes for the object, the set of latent codes including geometry latent codes and appearance latent codes;
generate a set of object primitives based on the set of latent codes for the object;
generate an appearance model of photometric interactions between the face and the object; and
render an avatar based on the appearance model, the set of face primitives, and the set of object primitives.

13. The system of claim 12, wherein the one or more processors are further configured to:
decode an encoding of a facial expression, face geometry, and face textures, wherein the set of face primitives include a tuple of a position, rotation, and scale of the set of face primitives, opacity of face primitives, and color of face primitives; and
generate the set of face primitives based on decoded results.

14. The system of claim 12, wherein the one or more processors are further configured to:
decode the set of latent codes for the object to generate the set of object primitives, wherein the set of object primitives include a tuple of a position, rotation, and scale of the set of object primitives, opacity of object primitives, and color of object primitives; and
generate the set of object primitives based on decoded results.

15. The system of claim 12, wherein the one or more processors are further configured to:
identify deformations caused by the object interacting with the face; and
model the deformations as residual deformation of the set of face primitives and the set of object primitives.

16. The system of claim 15, wherein the deformations include non-rigid deformation cause by the object fitting to the at least one subject and rigid deformation caused by facial expressions of the at least one subject.

17. The system of claim 12, wherein the one or more processors are further configured to:
deform a geometry and an appearance of the object to fit the face or head of the at least one subject based on geometry latent codes for the object and facial identity information;
infer a motion of the object on the face based on facial expressions of the at least one subject; and
generate deformation residuals based on the deformed geometry and appearance of the object and the motion.

18. The system of claim 12, wherein the appearance model includes: relightable appearance face modeling based on facial expression information, facial texture information in the set of face primitives, and color of face primitive in the set of face primitives; and relightable appearance object modeling based on object texture information in the set of object primitives, object identity information in the set of object primitives, a specular feature, and a shadow feature.

19. The system of claim 12, wherein the one or more processors are further configured to:
compute a specular feature at each point on the set of object primitives;
compute a shadow feature representing a first bounce of light transport on the face and the object;
identify a view direction and a light direction based on the image data; and
determine an appearance residual for the face based on the shadow feature, light direction, facial texture information in the set of face primitives, and object texture information in the set of object primitives.

20. A non-transient computer-readable storage medium having instructions embodied thereon, the instructions being executable by one or more processors to perform a method for modeling subjects in a virtual environment, the method comprising:
receiving, from a client device, image data including at least one subject;
extracting, from the image data, a face of the at least one subject and an eyeglass interacting with the face;
generating a set of face primitives based on the face, the set of face primitives comprising geometry and appearance information;
generate a set of latent codes for the eyeglass, the set of latent codes including geometry latent codes and appearance latent codes;
generating a set of eyeglass primitives based on the set of latent codes for the eyeglass;
generating an appearance model of photometric interactions between the face and the eyeglass; and
rendering an avatar based on the appearance model, the set of face primitives, and the set of eyeglass primitives.
